(19) United States
(12) Patent Application Publication
(10) Pub. No.: US 2016/0372282 A1
(43) Pub. Date: Dec. 22, 2016

(54) TACTILE SWITCH FOR A MOBILE ELECTRONIC DEVICE

(71) Applicant: Hand Held Products, Inc., Fort Mill, SC (US)

(72) Inventor: John Spencer Bandringa, Everett, WA (US)

(21) Appl. No.: 14/740,320

(22) Filed: Jun. 16, 2015

(51) Int. Cl. H01H 35/26

(52) U.S. Cl. CPC H01H 35/26; H01H 2221/038; H01H 2215/05

(57) ABSTRACT

A tactile switch on a mobile electronic device having a housing is provided. The tactile switch is comprised of a pressure sensitive interface on an exterior portion of the housing, a switch mechanism, and at least one pathway coupled to the pressure sensitive interface and extending from the pressure sensitive interface to the switch mechanism. The switch mechanism is at a remote location from the pressure sensitive interface. The pathway is formed in an interior portion of the housing. The tactile switch further includes a viscous fluid substantially filling the pathway. The tactile switch is configured such that when pressure is applied to the pressure sensitive interface, the viscous fluid exerts pressure on the switch mechanism, causing the switch to make an electrical contact.

### FIELD OF THE INVENTION

The present invention relates to mobile electronic devices such as smart phones and handheld computers, and particularly to button switches on such devices.

### BACKGROUND

Generally speaking as electronic devices become more mobile, portable, and smaller, these handheld electronic devices employ touch screens and touch gestures to operate features of the device. However, the need for traditional tactile button, or mechanical approach has not completely been eliminated.

Implementing traditional mechanical approach presents challenges. Often, an electronic device's internal components are competing for space which makes the mechanical approach particularly difficult to implement. The positioning of the input tactile buttons can lead to additional challenges such as RF interference or decreased durability.

Therefore, a need exists for tactile buttons for human input on handheld and portable electronic devices which have flexible positioning with respect to the switch or operation of the button controls, and which are efficient in the space they occupy within the device.

### SUMMARY

Accordingly, in one aspect, the present invention embraces a tactile switch on a mobile electronic device.

In an exemplary embodiment, a tactile switch on a mobile electronic device having a housing, includes a pressure sensitive interface on an exterior portion of the housing, a switch mechanism, and at least one pathway coupled to the pressure sensitive interface and extending from the pressure sensitive interface to the switch mechanism. The switch mechanism is at a remote location from the pressure sensitive interface. The pathway is formed in an interior portion of the housing. Additionally, a viscous fluid substantially fills the pathway. The tactile switch is configured such that when pressure is applied to the pressure sensitive interface, the viscous fluid in the pathway exerts pressure on the switch mechanism, causing the switch to make an electrical contact.

In another exemplary embodiment, the switch mechanism is mechanical.

In another exemplary embodiment, the switch mechanism is a solid state pressure sensor.

In another exemplary embodiment, the pressure sensitive interface is differentially sensitive to different pressures applied to the pressure sensitive interface.

In yet another exemplary embodiment of the invention, the pathway is molded into the interior portion of the housing.

In another exemplary embodiment, the viscous fluid is a hydraulic fluid.

In another exemplary embodiment, the pressure sensitive interface is comprised of more than one pressure sensitive interface. The at least one pathway is comprised of one pathway corresponding to each pressure sensitive interface. The tactile switch further comprises additional switch mechanisms corresponding to each pressure sensitive interface.

In another exemplary embodiment, the pressure sensitive interface may be located on any part of the exterior portion of the housing.

In another exemplary embodiment, the pressure sensitive interface has a shape. The shape conforms to a contour of the exterior portion of the housing where the pressure sensitive interface is located.

In yet another exemplary embodiment of the invention, the tactile switch further comprises means to transmit vibration to the exterior housing when the electrical contact is made with the switch mechanism.

In another exemplary embodiment of the invention, the vibration is transmitted to the pressure sensitive interface.

In another exemplary embodiment, the means to transmit vibration is selected from a solenoid and a vibrator, the means being activated by the switch making the electrical contact.

In another exemplary embodiment of the invention, the pathways are sealed.

In yet another exemplary embodiment of the invention, the pressure sensitive interface is directionally sensitive to pressure. The at least one pathway is comprised of one pathway corresponding to each direction in which the pressure sensitive interface is directionally sensitive. The tactile switch further comprises additional switch mechanisms corresponding to each pathway.

In another exemplary embodiment of the invention, the tactile switch further comprises means to transmit vibrations to the exterior housing when the electrical contact is made with one of the switch mechanisms. The vibrations are varied in property depending on which switch mechanism caused the electrical contact.

In another exemplary embodiment of the invention, the vibration property is selected from amplitude and frequency.

In another exemplary embodiment of the invention, the exterior portion of the housing of the mobile electronic device is comprised of a resilient material. The pressure sensitive interface is comprised of the entire exterior portion of the housing.

In another aspect, the present invention embraces a tactile switch on a mobile electronic device having a housing; the tactile switch comprising a pressure sensitive interface on an exterior portion of the housing, a switch mechanism, and means for transferring pressure from the pressure sensitive interface to the switch mechanism such that pressure applied to the pressure sensitive interface causes the switch mechanism to make an electrical contact via the means for transferring pressure. The switch mechanism is at a remote location from the pressure sensitive interface.

In another exemplary embodiment, the means for transferring pressure comprises at least one pathway coupled to the pressure sensitive interface and extending from the pressure sensitive interface to the switch mechanism. The pathway is formed in an interior portion of the housing. The means further comprises viscous fluid substantially filling the pathway.

In another exemplary embodiment, the tactile switch further comprises a reservoir containing the viscous fluid. The reservoir is located between the pressure sensitive interface and the pathway.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a mobile device with three tactile switches in accordance with an exemplary embodiment of the present invention.

FIGS. 2a and 2b schematically depict a tactile switch in an inactivated state and in an activated state respectively in accordance with an exemplary embodiment of the present invention.

FIGS. 3a and 3b schematically depict another tactile switch in an inactivated state and in an activated state respectively in accordance with another exemplary embodiment of the present invention.

FIGS. 4a and 4b schematically depict a further tactile switch in an inactivated state and in an activated state respectively in accordance with another exemplary embodiment of the present invention.

### DETAILED DESCRIPTION

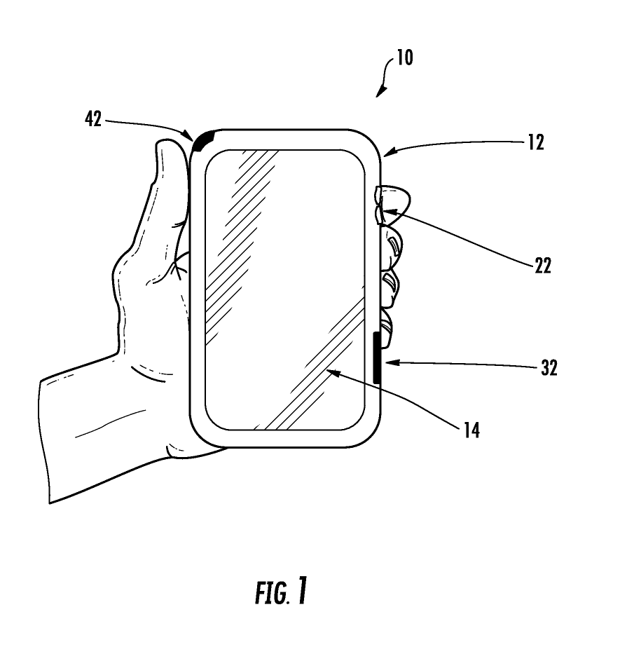

The present invention embraces a tactile switch for an electronic mobile device. FIG. 1 illustrates a mobile electronic device with three tactile switches in accordance with the present invention.

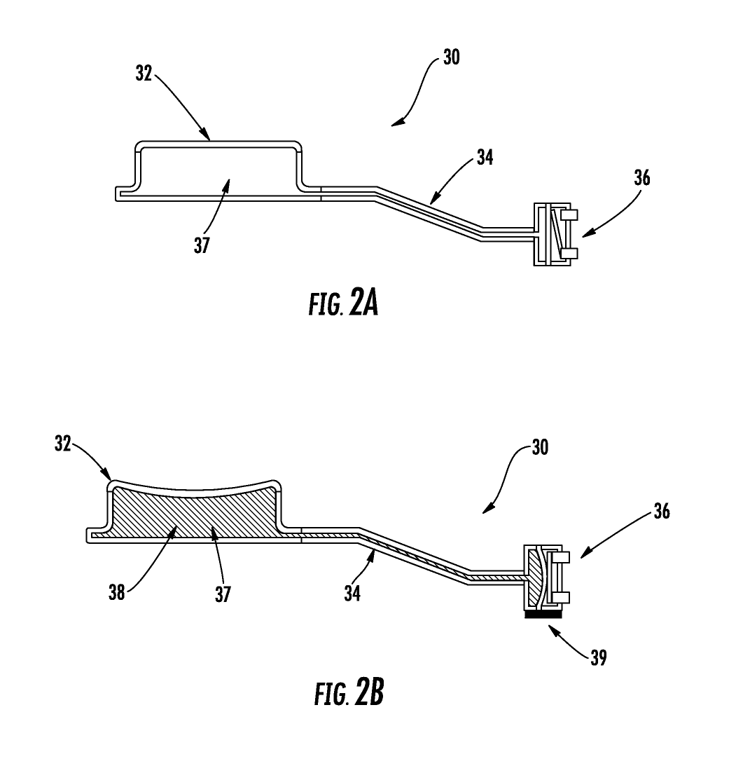

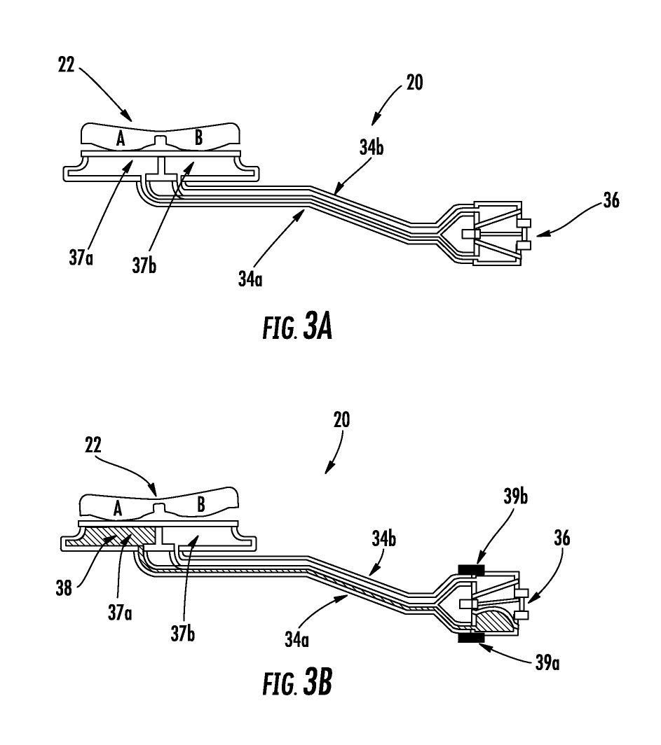

In an exemplary embodiment, referring to FIG. 1, a mobile electronic device (10) is provided with a housing (12) and a touchscreen (14). Pressure sensitive interfaces (22, 32, and 42) for tactile switches according to the present invention are provided as part of the housing or on an exterior portion of the housing (12). For example, pressure sensitive interface (42) is shaped to the contour of the housing of the mobile electronic device (10). Pressure sensitive interface (32) is flush with the housing (12) of the mobile electronic device (10). Pressure sensitive interface (22) is slightly elevated from the housing (12) of the mobile electronic device (10). The pressure sensitive interfaces (32) and (22) will be discussed in more detail in conjunction with FIGS. 2 and 3 respectively below. The housing (12) and the pressure sensitive interfaces (22, 32, 42) may be made of resilient material.

Referring now to FIG. 2a, in an exemplary embodiment of the present invention, the tactile switch (30) is comprised of a pressure sensitive interface (32), a switch mechanism (36) at a remote location from the pressure sensitive interface (32), and a pathway (34) coupled to the pressure sensitive interface (32) and extending from the pressure sensitive interface (32) to the switch mechanism (36). A reservoir (37) is provided between the pressure sensitive interface (32) and the pathway (34). The pathway (34) is formed in an interior portion of the housing. For example, the pathway may be etched or molded into a plastic housing of the mobile electronic device. Alternatively the pathway could be molded in another interior parts of the mobile device, thus saving valuable real estate.

Referring to FIG. 2b, in an exemplary embodiment, viscous fluid (38) fills the reservoir (37) and the pathway (34). In the Figure, the pressure sensitive interface (32) is shown as being depressed, which causes the viscous fluid (38) to exert pressure on the switch mechanism (36), causing the switch mechanism (36) to make an electrical contact.

In another exemplary embodiment, the tactile switch (30) also includes a vibration device (39). The vibration device (39), for example, may be a solenoid or a vibrator. The vibration device (39) is activated when the switch mechanism (36) makes an electrical contact. The vibration device (39) may be mechanically coupled to the pathway (34) such that vibration is transmitted to the pressure sensitive interface (32).

Referring now to FIG. 3a, tactile switch (20) is schematically shown. In an exemplary embodiment, tactile switch (20) is comprised of pressures sensitive interface (22), reservoirs (37a and 37b), pathways (34a and 34b), corresponding to reservoirs (37a and 37b), and switch mechanism (36). In the exemplary embodiment, the pressure sensitive interface (22) is actually comprised of two pressure sensitive interfaces (22a and 22b). Thus, tactile switch (20) is actually two switches or a switch with dual functions.

In another exemplary embodiment, referring to FIG. 3b, pressure sensitive interface (22a) is depressed. Viscous fluid (38) in reservoir (37a) is forced down pathway (34a) to exert pressure on switch mechanism (36). The pathways (34a and 34b) may be formed in an interior portion of the housing. For example, the pathways (34a and 34b) may be etched or molded into a plastic housing of the mobile electronic device. Alternatively the pathways (34a and 34b) could be molded in other interior parts of the mobile device, thus saving valuable real estate.

In another exemplary embodiment, the tactile switch (20) is provided with vibration devices (39a and 39b). The vibration devices (39a and 39b), for example may be solenoids or vibrators. One of the vibration devices (39a or 39b) is activated when the switch mechanism (36) makes an electrical contact, depending on whether pressure sensitive interface (22a or 22b) is depressed. The vibration devices (39a or 39b) may be mechanically coupled to the pathways (34a and 34b) such that vibration is transmitted to the corresponding pressure sensitive interface (22a or 22b).

In another exemplary embodiment, the vibrations are varied in property depending on which pressure sensitive interface (22a or 22b) is depressed. The property variation can be one of frequency or amplitude, which is transmitted to the pressure sensitive interface (22a or 22b) via the viscous fluid (38) in the corresponding pathway (34a or 34b).

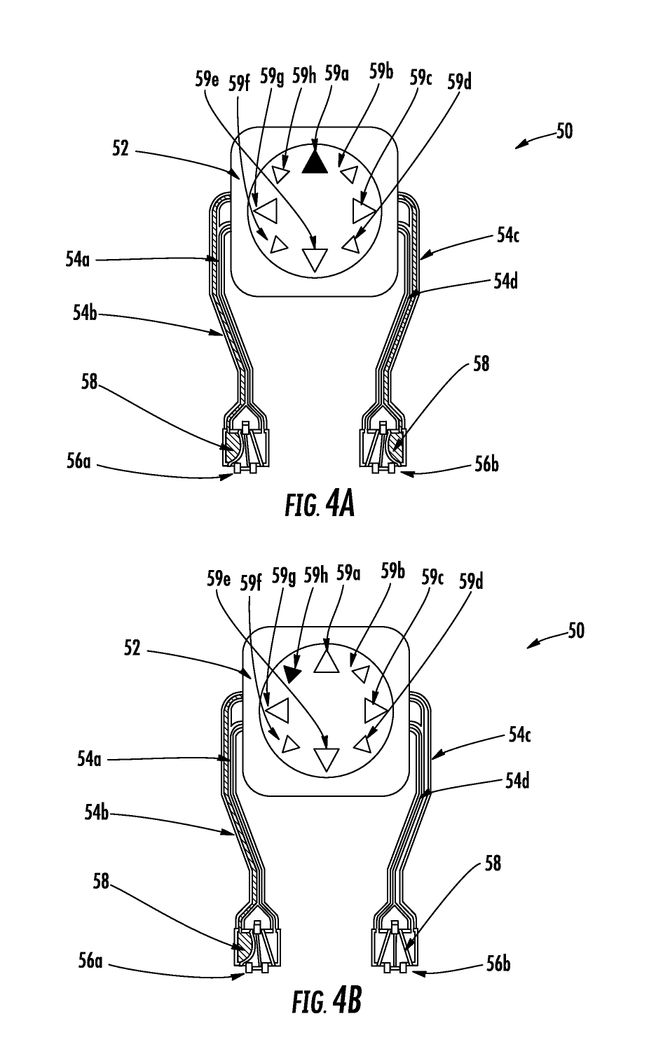

In another exemplary embodiment, the tactile switch's pressure sensitive interface is directionally sensitive to pressure. The pathway comprises one pathway corresponding to each direction in which the pressure sensitive interface is directionally sensitive. The tactile switch further is provided with additional switch mechanisms corresponding to each pathway. Referring to FIG. 4a, the tactile switch (50) is provided with a pressure sensitive interface (52) which is directionally sensitive to pressure. In the Figure, the directional sensitivity is designated by arrowheads (59a-59h) on the surface of the pressure sensitive interface (52), however these are present in the Figure for merely illustrative purposes and would not necessarily be present on an actual device. The tactile switch (50) also includes pathways (54a-54d), switch mechanisms (56a and 56b) and viscous fluid (58) in the pathways. Switch mechanisms (56a and 56b) each have two possible electrical contact positions, corresponding to the four pathways (54a-54d). In FIG. 4a, when the pressure sensitive interface (52) is pressed in the direction of the blackened arrow head (59a), viscous fluid (58) flows in pathways (54b and 54c) to exert pressure on the switch mechanisms (56a and 56b) to make an electrical connection. Similarly, in other exemplary embodiments, depressing the pressure sensitive interface (52) in the (59b) direction results in viscous fluid (58) flow in pathway (54c); or in direction (59c) results in viscous fluid (58) flow in pathways (54b and 54c); or in the direction (59d) results in viscous fluid (58) flow in pathways (54d); or in direction (59e) results in viscous fluid (58) flow in pathways (54a and 54d); or in the direction (59f) results in viscous fluid (58) flow in pathways (54a); or in direction (59g) results in viscous fluid (58) flow in pathways (54a and 54c).

Referring now to FIG. 4b, in another exemplary embodiment, on the tactile switch (50), the pressure sensitive interface (52) is depressed the direction of blackened arrow head (52h). This depression causes viscous fluid (58) to flow through pathway (54b) to exert pressure on switch mechanism (56a) to make an electrical contact.

In another exemplary embodiment, in all the foregoing examples, the switch mechanism, when making electrical contact, activates some feature of the electronic mobile device.

The following represent additional exemplary embodiments.

### Embodiment 1

A tactile switch on a mobile electronic device having a housing, comprising:

a pressure sensitive interface on an exterior portion of the housing;

a switch mechanism, the switch mechanism being at a remote location from the pressure sensitive interface;

at least one pathway coupled to the pressure sensitive interface and extending from the pressure sensitive interface to the switch mechanism, the pathway being formed in an interior portion of the housing;

a viscous fluid substantially filling the pathway; and

the tactile switch being configured such that when pressure is applied to the pressure sensitive interface, the viscous fluid exerts pressure on the switch mechanism, causing the switch to make an electrical contact.

### Embodiment 2

The tactile switch of Embodiment 1, wherein the switch mechanism is mechanical.

### Embodiment 3

The tactile switch of Embodiment 1, wherein the switch mechanism is a solid state pressure sensor.

### Embodiment 4

The tactile switch of Embodiment 1, wherein the pathway is molded into the interior portion of the housing.

### Embodiment 5

The tactile switch of Embodiment 3, wherein the pressure sensitive interface is differentially sensitive to different pressures applied to the pressure sensitive interface.

### Embodiment 6

The tactile switch of Embodiment 1, wherein the viscous fluid is a hydraulic fluid.

### Embodiment 7

The tactile switch of Embodiment 1, wherein the pressure sensitive interface comprises more than one pressure sensitive interface; wherein the at least one pathway comprises one pathway corresponding to each pressure sensitive interface; the tactile switch further comprising additional switch mechanisms corresponding to each pressure sensitive interface.

### Embodiment 8

The tactile switch of Embodiment 1, wherein the pressure sensitive interface may be located on any part of the exterior portion of the housing.

### Embodiment 9

The tactile switch of Embodiment 1, wherein the pressure sensitive interface has a shape, the shape conforming to a contour of the exterior portion of the housing where the pressure sensitive interface is located.

### Embodiment 10

The tactile switch of Embodiment 1, further comprising means to transmit vibration to the exterior housing when the electrical contact is made with the switch mechanism.

### Embodiment 11

The tactile switch of Embodiment 10, wherein the vibration is transmitted to the pressure sensitive interface.

### Embodiment 12

The tactile switch of Embodiment 10, wherein the means to transmit vibration is selected from a solenoid and a vibrator, the means being activated by the switch making the electrical contact.

### Embodiment 13

The tactile switch of Embodiment 1, wherein the pathways are sealed.

### Embodiment 14

The tactile switch of Embodiment 1, wherein the pressure sensitive interface is directionally sensitive to pressure, and wherein the at least one pathway comprises one pathway corresponding to each direction in which the pressure sensitive interface is directionally sensitive; the tactile switch further comprising additional switch mechanisms corresponding to each pathway.

### Embodiment 15

The tactile switch of Embodiment 14, further comprising means to transmit vibrations to the exterior housing when the electrical contact is made with one of the switch mechanisms, the vibrations being varied in property depending on which switch mechanism caused the electrical contact.

### Embodiment 16

The tactile switch of Embodiment 15, wherein the property is selected from amplitude and frequency.

### Embodiment 17

The tactile switch of Embodiment 1, wherein the exterior portion of the housing of mobile electronic device is comprised of a resilient material; and wherein the pressure sensitive interface is comprised of the entire exterior portion of the housing.

### Embodiment 18

A tactile switch on a mobile electronic device having a housing, comprising:

a pressure sensitive interface on an exterior portion of the housing;

a switch mechanism, the switch mechanism being at a remote location from the pressure sensitive interface;

means for transferring pressure from the pressure sensitive interface to the switch mechanism, such that pressure applied to the pressure sensitive interface causes the switch mechanism to make an electrical contact.

### Embodiment 19

The tactile switch of 18, wherein the means for transferring pressure comprises,

at least one pathway coupled to the pressure sensitive interface and extending from the pressure sensitive interface to the switch mechanism, the pathway being formed in an interior portion of the housing; and

viscous fluid substantially filling the pathway.

### Embodiment 20

The tactile switch of Embodiment 18, wherein the switch mechanism is mechanical.

### Embodiment 21

The tactile switch of Embodiment 18, wherein the switch mechanism is a solid state pressure sensor.

### Embodiment 22

The tactile switch of Embodiment 19, wherein the pathway is molded into the interior portion of the housing.

### Embodiment 23

The tactile switch of Embodiment 21, wherein the pressure sensitive interface is differentially sensitive to different pressures applied to the pressure sensitive interface.

### Embodiment 24

The tactile switch of Embodiment 19, wherein the viscous fluid is a hydraulic fluid.

### Embodiment 25

The tactile switch of Embodiment 19, wherein the pressure sensitive interface comprises more than one pressure sensitive interface; and wherein the at least one pathway comprises one pathway corresponding to each pressure sensitive interface; the tactile switch further comprising additional switch mechanisms corresponding to each pressure sensitive interface.

### Embodiment 26

The tactile switch of Embodiment 18, wherein the pressure sensitive interface may be located on any part of the exterior portion of the housing.

### Embodiment 27

The tactile switch of Embodiment 18, wherein the pressure sensitive interface has a shape, the shape conforming to a contour of the exterior portion of the housing where the pressure sensitive interface is located.

### Embodiment 28

The tactile switch of Embodiment 18, further comprising means to transmit vibration to the exterior housing when the electrical contact is made with the switch mechanism.

### Embodiment 29

The tactile switch of Embodiment 28, wherein the vibration is transmitted to the pressure sensitive interface.

### Embodiment 30

The tactile switch of Embodiment 28, wherein the means to transmit vibration is selected from a solenoid and a vibrator, the means being activated by the switch making the electrical contact.

### Embodiment 31

The tactile switch of Embodiment 19, wherein the pathways are sealed.

### Embodiment 32

The tactile switch of Embodiment 19, wherein the pressure sensitive interface is directionally sensitive to pressure, and wherein the at least one pathway comprises one pathway corresponding to each direction in which the pressure sensitive interface is directionally sensitive; the tactile switch further comprising additional switch mechanisms corresponding to each pathway.

### Embodiment 33

The tactile switch of Embodiment 32, further comprising means to transmit vibrations to the exterior housing when the electrical contact is made by one of the switch mechanisms, the vibrations being varied in property depending on which switch mechanism caused the electrical contact.

### Embodiment 34

The tactile switch of Embodiment 33, wherein the property is selected from amplitude and frequency.

### Embodiment 35

The tactile switch of Embodiment 18, wherein the exterior portion of the housing of mobile electronic device is comprised of a resilient material; and wherein the pressure sensitive interface is comprised of the entire exterior portion of the housing.

### Embodiment 36

The tactile switch of Embodiment 1, further comprising a reservoir containing the viscous fluid located between the pressure sensitive interface and the pathway.

### Embodiment 37

The tactile switch of Embodiment 19, further comprising a reservoir containing the viscous fluid located between the pressure sensitive interface and the pathway.

To supplement the present disclosure, this application incorporates entirely by reference the following commonly assigned patents, patent application publications, and patent applications:

To supplement the present disclosure, this application incorporates entirely by reference the following patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTON CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. Patent Application No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 29/486,759 for an Imaging Terminal, filed Apr. 2, 2014 (Oberpriller et al.);
U.S. patent application Ser. No. 29/492,903 for an INDICIA SCANNER, filed Jun. 4, 2014 (Zhou et al.); and
U.S. patent application Ser. No. 29/494,725 for an IN-COUNTER BARCODE SCANNER, filed Jun. 24, 2014 (Oberpriller et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A tactile switch on a mobile electronic device having a housing, comprising:
a pressure sensitive interface on an exterior portion of the housing;
a switch mechanism, the switch mechanism being at a remote location from the pressure sensitive interface;
at least one pathway coupled to the pressure sensitive interface and extending from the pressure sensitive interface to the switch mechanism, the pathway being formed in an interior portion of the housing;
a viscous fluid substantially filling the pathway; and
the tactile switch being configured such that when pressure is applied to the pressure sensitive interface, the viscous fluid exerts pressure on the switch mechanism, causing the switch to make an electrical contact.

2. The tactile switch of claim 1, wherein the switch mechanism is mechanical.

3. The tactile switch of claim 1, wherein the switch mechanism is a solid state pressure sensor.

4. The tactile switch of claim 1, wherein the pathway is molded into the interior portion of the housing.

5. The tactile switch of claim 3, wherein the pressure sensitive interface is differentially sensitive to different pressures applied to the pressure sensitive interface.

6. The tactile switch of claim 1, wherein the viscous fluid is a hydraulic fluid.

7. The tactile switch of claim 1, wherein the pressure sensitive interface comprises more than one pressure sensitive interface; wherein the at least one pathway comprises one pathway corresponding to each pressure sensitive interface; the tactile switch further comprising additional switch mechanisms corresponding to each pressure sensitive interface.

8. The tactile switch of claim 1, wherein the pressure sensitive interface has a shape, the shape conforming to a contour of the exterior portion of the housing where the pressure sensitive interface is located.

9. The tactile switch of claim 1, further comprising a vibration device to transmit vibration to the exterior housing when the electrical contact is made with the switch mechanism.

10. The tactile switch of claim 9, wherein the vibration is transmitted to the pressure sensitive interface.

11. The tactile switch of claim 9, wherein the vibration device is selected from a solenoid and a vibrator, the vibration device being activated by the switch making the electrical contact.

12. A tactile switch on a mobile electronic device having a housing, comprising:
a pressure sensitive interface on an exterior portion of the housing;
a switch mechanism, the switch mechanism being at a remote location from the pressure sensitive interface;
means for transferring pressure from the pressure sensitive interface to the switch mechanism, such that pressure applied to the pressure sensitive interface causes the switch mechanism to make an electrical contact.

13. The tactile switch of 12, wherein the means for transferring pressure comprises,
at least one pathway coupled to the pressure sensitive interface and extending from the pressure sensitive interface to the switch mechanism, the pathway being formed in an interior portion of the housing; and
viscous fluid substantially filling the pathway.

14. The tactile switch of claim 12, wherein the switch mechanism is mechanical.

15. The tactile switch of claim 12, wherein the switch mechanism is a solid state pressure sensor.

16. The tactile switch of claim 13, wherein the pathway is molded into the interior portion of the housing.

17. The tactile switch of claim 15, wherein the pressure sensitive interface is differentially sensitive to different pressures applied to the pressure sensitive interface.

18. The tactile switch of claim 13, wherein the viscous fluid is a hydraulic fluid.

19. The tactile switch of claim 13, wherein the pressure sensitive interface comprises more than one pressure sensitive interface; and wherein the at least one pathway comprises one pathway corresponding to each pressure sensitive interface; the tactile switch further comprising additional switch mechanisms corresponding to each pressure sensitive interface.

20. The tactile switch of claim 12, further comprising a vibration device to transmit vibration to the exterior housing when the electrical contact is made with the switch mechanism.
